(19) United States
(12) Patent Application Publication
(10) Pub. No.: US 2013/0318072 A1
(43) Pub. Date: Nov. 28, 2013

(54) SEARCHING APPARATUS, AND SEARCHING METHOD

(71) Applicant: FUJITSU LIMITED, Kawasaki-shi (JP)

(72) Inventors: Takafumi OHTA, Chuo (JP); Takahiro Murata, Yokohama (JP); Masahiro Kataoka, Tama (JP)

(73) Assignee: Fujitsu Limited, Kawasaki-shi (JP)

(21) Appl. No.: 13/848,833

(22) Filed: Mar. 22, 2013

(30) Foreign Application Priority Data
May 24, 2012 (JP) 2012-119099

(51) Int. Cl. G06F 17/30

(52) U.S. Cl. CPC G06F 17/30424
USPC 707/722

(57) ABSTRACT

A searching apparatus includes a processor configured to receive searching character information, in a case that document data includes a designation that first character information and second character information are provided in adscript description, to copy state information indicating a state of a collating process of the searching character information on third character information in front of the designation in the document data, to update the state information based on a result of collating the first character information with the searching character information, and to update the copied state information based on a result of collating the second character information with the searching character information.

### CROSS-REFERENCE TO RELATED APPLICATION

This application is based upon and claims the benefit of priority of the prior Japanese Patent Application No. 2012-119099, filed on May 24, 2012, the entire contents of which are incorporated herein by reference.

### FIELD

The embodiment discussed herein is related to data search technology.

### BACKGROUND

In markup languages such as html, modification information of text (designation of the size of characters, a state of composition, and the like) is designated by using a tag which is expressed by a text or the like. Examples of modification based on modification information include such modification that a language unit having one meaning (a unit constituting a language, such as a word and a character) is written with character information by a plurality of different notations (for example, a notation of a character string provided with reading, a notation of Chinese provided with pinyin and the like). In a text written by a markup language, a notation (display rules such as a display position and a display size) is designated by a tag. For example, in a case where a ruby annotation is provided to a character string, whether to be notation designated for a reading character or notation designated for a character to which reading is to be provided (parent character) is discriminated by a tag. Based on the tag designating the ruby annotation, the parent character and the reading character (or the notation) are adscripted. In html, a part of character information of ““tana” “bata” “matsu” “ri”” (each of “tana”, “bata”, and “matsu” expresses one Chinese character corresponding to one character code and “ri” expresses one Hiragana character corresponding to one character code in the original specification) is expressed by description (description D1) such as “<ruby><rb>“tana” “bata”</rb><rp>(</rp><rt>“ta” “na” “ba” “ta”</rt><rp>)</rp><rb>“matsu”</rb><rp>(</rp><rt>“ma” “tsu”</rt><rp>)</rp></ruby>“ri””, for example. In the case of the description D1, ““tana” “bata”” (each of “tana” and “bata” expresses one Chinese character in the original specification) are parent characters and ““ta” “na” “ba” “ta”” (each of “ta”, “na”, “ba”, and “ta” expresses one Hiragana character in the original specification) are reading characters. The description D1 is ““tana” “bata” . . . “ta” “na” “ba” “ta” . . . “matsu” . . . “ma” “tsu” . . . “ri”” when tag information is excluded. Therefore, when searching is performed by using a search string such as ““tana” “bata” “matsu” “ri””, it is determined that ““tana” “bata” . . . “ta” “na” “ba” “ta” . . . “matsu” . . . “ma” “tsu” . . . “ri”” does not accord with the search string.

To such problem, such technique has been disclosed that information for discriminating a character string with no reading, a parent character, and a reading character is associated with character information (except for a tag) in a document which is a search object, so as to collate the search string only with a character which is associated with discrimination information which is same as a character according with a first character of the search string. When the head of the search string and a parent character are accorded with each other in the collation, collation with reading characters existing up to a following parent character is skipped and collation with the parent character existing after the skipped reading characters is performed.

However, when the head character of the search string accords with the parent character, collation with reading is skipped. Therefore, it is determined that the search string is not accorded with character information in a document when part of the search string is accorded with the parent character and other parts are accorded with the reading character. For example, it is determined that search strings such as ““tana” “bata” “ma” “tsu” “ri”” and ““ta” “na” “ba” “ta” “matsu” “ri”” are not included in the description D1.

For example, Japanese Laid-open Patent Publication No. 2003-330917 is issued.

### SUMMARY

According to an aspect of the invention, a searching apparatus includes a processor configured to receive searching character information, in a case that document data includes a designation that first character information and second character information are provided in adscript description, to copy state information indicating a state of a collating process of the searching character information on third character information in front of the designation in the document data, to update the state information based on a result of collating the first character information with the searching character information, and to update the copied state information based on a result of collating the second character information with the searching character information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a function block of a computer;

FIG. 2 is a exemplary diagram of an automaton;

FIG. 3 illustrates a data configuration example of an automaton;

FIG. 4 illustrates an example of state information;

FIG. 5 illustrates an example of a table indicating a part according with a search string;

FIG. 6 illustrates time-series change of storage regions;

FIG. 7 illustrates the exemplary system configuration including the computer;

FIG. 8 illustrates the exemplary hardware configuration of the computer;

FIG. 9 illustrates the exemplary software configuration of the computer;

FIG. 10 illustrates an exemplary flowchart of search processing performed by a search unit;

FIG. 11 illustrates an automaton generation flowchart;

FIG. 12A illustrates an exemplary flowchart of collation;

FIG. 12B illustrates an exemplary flowchart of the collation;

FIG. 13A is an exemplary diagram of an automaton;

FIG. 13B is an exemplary diagram of an automation;

FIG. 14A illustrates time-series change of storage regions;

FIG. 14B illustrates time-series change of storage regions; and

FIG. 15 illustrates time-series change of storage regions.

### DESCRIPTION OF EMBODIMENTS

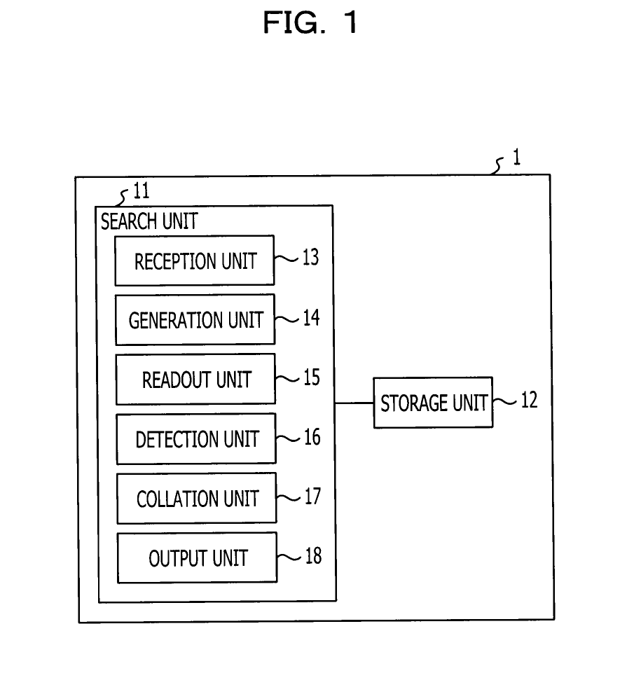

FIG. 1 illustrates an example of a function block of a computer 1 according to a first embodiment. The computer 1 includes a search unit 11 and a storage unit 12. The storage unit 12 stores a file group F1 to Fn which is a search object, for example. The search unit 11 performs searching with respect to the file group F1 to Fn which is stored in the storage unit 12.

The search unit 11 includes a reception unit 13, a generation unit 14, a readout unit 15, a detection unit 16, a collation unit 17, and an output unit 18. The reception unit 13 receives a search request including designation of a search string. The generation unit 14 generates an automaton on the basis of a search string which is included in a search request which is received by the reception unit 13. The readout unit 15 performs control of readout of the file group F1 to Fn which is a search object. The detection unit 16 detects designation for displaying character information having one meaning in a plurality of notations, from a file (referred to as a file Fi) which is read out through the control of the readout unit 15. When the detection unit 16 detects designation for displaying character information having one meaning in a plurality of notations (for example, tag information for designating insertion of reading), the detection unit 16 notifies the collation unit 17 of a part including the designation. The collation unit 17 performs collation between character information in a file (referred to as a file Fi) which is read out by the readout unit 15 and a search string by using an automaton which is generated by the generation unit 14. When the collation unit 17 receives notification from the detection unit 16, the collation unit 17 duplicates state information indicating a state of an automaton at a part indicated in the notification, so as to obtain two pieces of state information. Further, the collation unit 17 reflects a result of collation with one character string having overlapped semantic content, with respect to one piece of the state information and reflects a result of collation with the other character string having overlapped semantic content, with respect to the other piece of state information. The output unit 18 outputs a result of collation performed by the collation unit 17.

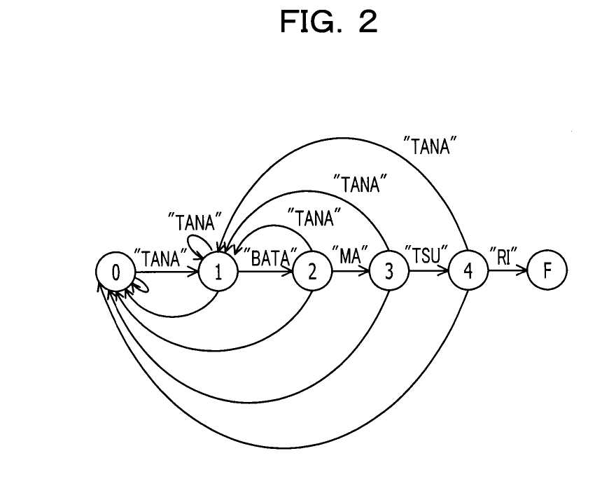

FIG. 2 is a model diagram of an automaton which is generated by the generation unit 14. An automaton depicted in FIG. 2 corresponds to a search string which is ““tana” “bata” “ma” “tsu” “ri””. The collation unit 17 performs determination of whether character information satisfies a state transition condition included in the automaton, for every piece of character information which is sequentially read from files which are search objects.

First, every time the collation unit 17 reads out character information from a file Fi which is read by the readout unit 15, the collation unit 17 repeats determination of whether or not the character information satisfies a transition condition in an initial state of an automaton, for example. That is, the collation unit 17 reads out character information from the file Fi in sequence so as to collate the character information with character information of “tana” of a transition condition 1 which is a condition of transition from an initial state (0) to a following state (1). When the character information which is read from the file Fi is accorded with “tana” of the transition condition 1 in the result of the collation, the collation unit 17 shifts a state of the automaton to the state (1).

When the state of the automaton is shifted to the state (1), the collation unit 17 determines whether or not character information satisfies a transition condition in the state (1). That is, the collation unit 17 collates character information which is read from the file Fi subsequent to the transition to the state (1), with character information of “bata” of a transition condition 1 which is a condition of transition from the state (1) to a state (2). When the character information which is read out is accorded with the character information of “bata” in the result of the collation, the collation unit 17 shifts the state of the automaton to the state (2). Further, the collation unit 17 collates character information which is read out, with character information of “tana” of a transition condition 2 which is a condition of transition from the state (1) to the state (1). When the character information which is read out is accorded with the character information of “tana” in the result of the collation, the collation unit 17 shifts the state of the automaton to the state (1). When the character information which is read out is accorded with neither the transition condition 1 nor the transition condition 2 in the result of the collation, the collation unit 17 returns the state of the automaton to the initial state (0).

When the state of the automaton is shifted to the state (2), the collation unit 17 determines whether or not character information satisfies a transition condition in the state (2). That is, the collation unit 17 collates character information which is read from the file Fi subsequent to the transition to the state (2), with character information of “ma” of a transition condition 1 which is a condition of transition from the state (2) to a state (3). When the character information which is read out is accorded with the character information of “ma” in the result of the collation, the collation unit 17 shifts the state of the automaton to the state (3). Further, the collation unit 17 collates the character information which is read out, with character information of “tana” of a transition condition 2 which is a condition of transition from the state (2) to the state (1). When the character information which is read out is accorded with the character information of “tana” in the result of the collation, the collation unit 17 shifts the state of the automaton to the state (1). When the character information which is read out is accorded with neither the transition condition 1 nor the transition condition 2 in the result of the collation, the collation unit 17 returns the state of the automaton to the initial state (0).

When the state of the automaton is shifted to the state (3), the collation unit 17 determines whether or not character information satisfies a transition condition in the state (3). That is, the collation unit 17 collates character information which is read from the file Fi subsequent to the transition to the state (3), with character information of “tsu” of a transition condition 1 which is a condition of transition from the state (3) to a state (4). When the character information which is read out is accorded with the character information of “tsu” in the result of the collation, the collation unit 17 shifts the state of the automaton to the state (4). Further, the collation unit 17 collates the character information which is read out, with character information of “tana” of a transition condition 2 which is a condition of transition from the state (3) to the state (1). When the character information which is read out is accorded with the character information of “tana” in the result of the collation, the collation unit 17 shifts the state of the automaton to the state (1). When the character information which is read out is accorded with neither the transition condition 1 nor the transition condition 2 in the result of the collation, the collation unit 17 returns the state of the automaton to the initial state (0).

When the state of the automaton is shifted to the state (4), the collation unit 17 determines whether or not character information satisfies a transition condition in the state (4). That is, the collation unit 17 collates character information which is read from the file Fi subsequent to the transition to the state (4), with character information of “ri” of a transition condition 1 which is a condition of transition from the state (4) to a state (F). When the character information which is read out is accorded with the character information of “ri” in the result of the collation, the collation unit 17 shifts the state of the automaton to the state (F). Further, the collation unit 17 collates the character information which is read out, with character information of “tana” of a transition condition 2 which is a condition of transition from the state (4) to the state (1). When the character information which is read out is accorded with the character information of “tana” in the result of the collation, the collation unit 17 shifts the state of the automaton to the state (1). When the character information which is read out is accorded with neither the transition condition 1 nor the transition condition 2 in the result of the collation, the collation unit 17 returns the state of the automaton to the initial state (0). When the state of the automaton is shifted to the state (F), the collation unit 17 stores information, which enables the character information, which has been read in the transition to the state (F), to be specified, in the storage unit 12. Information which is stored in the storage unit 12 is a position, in the file Fi, of a character string which is accorded with a search string, for example. Information indicating a position in the file Fi may be the number of pieces of character information which are read from the start of readout of the file Fi to the transition to the state (F), for example.

The collation unit 17 sequentially performs determination of state transition of an automaton in the above-described procedure. Accordingly, when the collation unit 17 reads out character information in succession from the file Fi in an order of “tana”→“bata”→“ma”→“tsu”→“ri”, the collation unit 17 determines that the search string ““tana” “bata” “ma” “tsu” “ri”” is included.

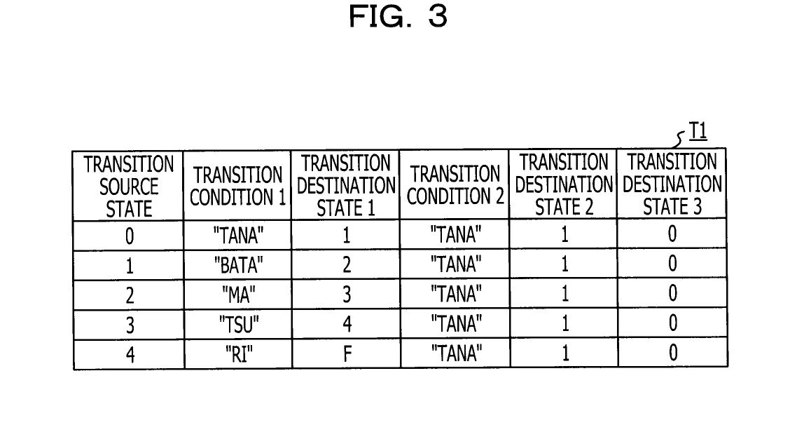

Determination of each state transition of an automaton performed by the collation unit 17 is now described in more detail. FIG. 3 illustrates the data configuration (table T1) of the automaton which is depicted in the model diagram of FIG. 2. The table T1 depicted in FIG. 3 indicates a transition destination state and a transition condition in a case where each state of the automaton, which is depicted in FIG. 2, is a transition source state. In the table T1, a combination of a transition condition 1 and a transition destination state 1, a combination of a transition condition 2 and a transition destination state 2, and a transition destination state 3 are associated with each transition source state. For example, when the state of the automaton is the initial state (0) and the transition condition 1 (“tana” in the example of FIG. 2) is satisfied, the state of the automaton is shifted to the transition destination state 1. Further, when the transition condition 2 is satisfied, the state of the automaton is shifted to the transition destination state 2. When neither the transition condition 1 nor the transition condition 2 is satisfied, the state of the automaton is shifted to the transition destination state 3.

The table T1 is generated through processing of the generation unit 14. When the reception unit 13 receives a search string, the generation unit 14 generates the table T1 depicted in FIG. 3 in accordance with an order of respective pieces of character information which are included in the search string so as to store the table T1 in the storage unit 12.

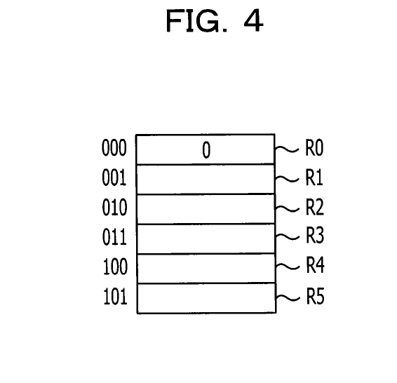

FIG. 4 illustrates an example of state information indicating a state. State information is stored in a storage region R0 depicted in FIG. 4. The storage region R0 may be a storage region provided in the storage unit 12 or a storage region in a register included in the search unit 11. For example, the storage region R0 is assumed to be a storage region denoted by an address “000”. In a case where a plurality of pieces of state information are used, a storage region R1 adjoining to the storage region R0 (for example, a storage region which is denoted by an address “001” which corresponds to a value obtained by incrementing the address of the storage region R0) is used.

The collation unit 17 performs the collation which has been described with reference to the model diagram of FIG. 2 by referring to the table T1 which is stored in the storage unit 12 and state information which is stored in the storage region. For example, the collation unit 17 acquires state information through the reference to the storage region R0 and extracts a record, in which a state which is indicated in the acquired state information is set as a transition source state, from the table T1 which is stored in the storage unit 12. Subsequently, the collation unit 17 acquires character information from the file Fi and determines whether or not the character information which is acquired satisfies a transition condition which is indicated in the extracted record. Further, when the acquired character information satisfies the transition condition, the collation unit 17 updates the state information which is stored in the storage region R0 to state information which indicates a transition destination state corresponding to the satisfied transition condition. When the acquired character information satisfies no transition conditions, the collation unit 17 updates the state information which is stored in the storage region R0 to state information indicating the initial state (0).

When the collation unit 17 starts collation of the file Fi, the collation unit 17 first holds state information indicating the initial state (0) in the storage region R0. For example, when information held in the storage region R0 indicates the initial state (0) and the collation unit 17 reads out character information of “tana” from the file Fi, the collation unit 17 updates the state information which is held in the storage region R0 from the state information indicating the initial state (0) to state information indicating the state (1).

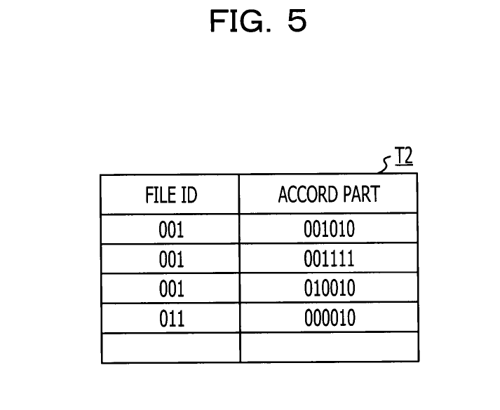

When state information indicating the state (F) is held in the storage region R0, the collation unit 17 determines accordance with the search string ““tana” “bata” “ma” “tsu” “ri”” and stores information indicating a part, in the file Fi, according with the search string, in a table T2 of the storage unit 12. FIG. 5 illustrates the table T2. The table T2 associates information for identifying a file Fi which includes character information according with a search string, with information indicating a position in the file.

Control of the collation unit 17 in a case where the collation unit 17 receives a notification from the detection unit 16 is now described. In readout of character information from the file Fi performed by the collation unit 17, the detection unit 16 determines whether or not designation for displaying character information having one meaning in a plurality of notations is included in document data. The designation is, for example, a <ruby> tag, <rb>, <rt>, and the like, which are tag information for designating reading notation in extensible hypertext markup language (xhtml) or the like. In document data using xhtml, character information inserted between <rb> tags is written as a parent character and character information inserted between <rt> tags is written as a reading character, in a range inserted between <ruby> tags. When the detection unit 16 detects a <rb> tag, for example, the detection unit 16 notifies the collation unit 17 of the detection of the <rb> tag. When the collation unit 17 receives the notification and detects that the <rb> tag is read from the file Fi, the collation unit 17 duplicates state information which is held in the storage region R0 and allows the storage region R1 to hold the state information, for example. Further, the collation unit 17 reflects automaton transition by a parent character of reading (character information inserted between <rb> tags) with respect to one piece of state information (stored in the storage region R0) which is obtained through the duplication and reflects automaton transition by a reading character (character information inserted between <rt> tags) with respect to the other piece of state information (stored in the storage region R1) which is obtained through the duplication.

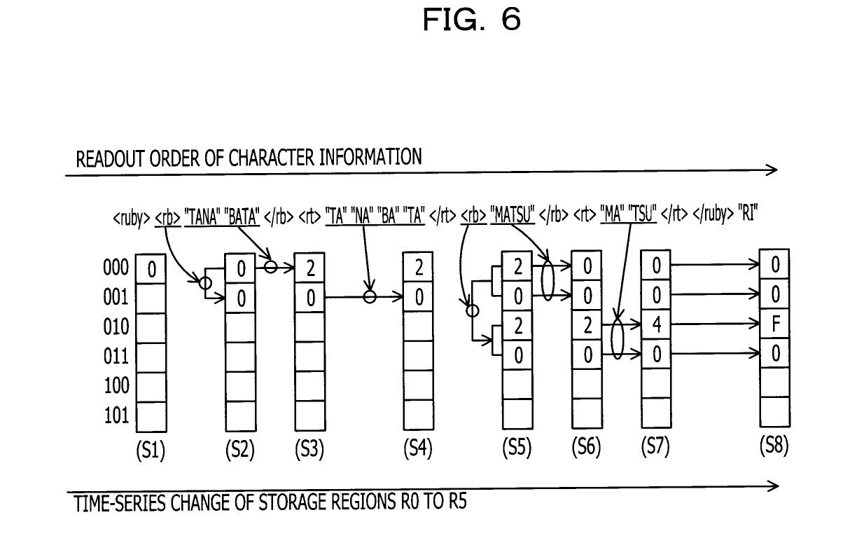

For example, it is assumed that the description D1 is read from the file Fi when state information indicates the initial state (0). Further, it is assumed that a search string is ““tana” “bata” “ma” “tsu” “ri””. FIG. 6 illustrates time-series change of storage regions R0 to R5 in a case where the description D1 is read out. First, it is assumed that state information stored in the storage region R0 is “0” and information stored in the storage regions R0 to R5 is as depicted as (S1), before the description D1 is read out.

When the collation unit 17 receives notification from the detection unit 16 and detects a <rb> tag, the collation unit 17 stores state information, which has been stored in the storage region R0, in the storage region R1. The information which is stored in the storage regions R0 to R5 is as depicted as (S2) in this case. A storage region to be a duplication destination is determined depending on, for example, a storage region which is a duplicate source and multiplicity of the duplication. When the collation unit 17 duplicates state information which is stored in the storage region R0, the collation unit 17 copies the state information which is stored in the storage region R0 onto the storage region R1 (denoted by the address “001”) due to the first duplication. In this case, a storage region which has an address of which a value of the lowest digit is “0” is a duplication source and a storage region which has an address of which a value of the lowest digit is “1” is a duplication destination. When duplication is further performed, state information of a storage region having an address of which a value of the second lowest digit is “0” (a storage region denoted by an address such as 000 and 001) is copied onto a storage region having an address of which a value of the second lowest digit is “1” (a storage region denoted by an address such as 010 and 011) due to the second duplication. The above-described addressing enables switching of storage regions, to which a collation result is reflected, through collation of character information inserted between <rb> tags and collation of character information inserted between <rt> tags, even when a <rb> tag is detected in a plurality of times. For example, the collation unit 17 switches storage regions depending on a value “0” or “1” of the lowest digit of an address in the first detection of a <rb> tag, and switches storage regions depending on a value “0” or “1” of the second lowest digit of an address in the second detection of a <rb> tag.

Subsequently, the collation unit 17 refers to the state information of the storage region R0 (denoted by the address “000”) and the automaton (table T1) so as to read out a transition condition. Further, the collation unit 17 determines whether or not “tana” which is the head character which is read from a range inserted between <rb> tags of the file Fi satisfies the transition condition. In this case, the search string is ““tana” “bata” “ma” “tsu” “ri”” and the head character which is read from the file Fi is “tana”, so that the state information stored in the storage region R0 is updated from the initial state (0) to the state (1). Further, the collation unit 17 determines whether or not “bata” which is read after “tana” satisfies a condition of transition from the state (1) to the state (2). In this case, “bata” satisfies the condition of transition from the state (1) to the state (2), so that the collation unit 17 updates the state information which is stored in the storage region R0 to the state information indicating the state (2). Information stored in the storage regions R0 to R5 in this case is as depicted as (S3).

The collation unit 17 performs collation with respect to “ta” which is inserted between <rt> tags, after the processing of “bata”. The collation unit 17 refers to the storage region R1 (denoted by the address “001”) and the table T1 so as to read out a transition condition. Character information “ta” which is read out is not accorded with the condition “tana” of transition to the state (1), so that the state information stored in the storage region R1 is left as the initial state (0). When the collation unit 17 reads out any of “na”, “ba”, and “ta” from the file Fi, as well, the collation unit 17 maintains the state information stored in the storage region R1 as the initial state (0) as is the case with “ta”. Information stored in the storage regions R0 to R5 in this case is as depicted as (S4).

Then, the detection unit 16 detects readout of a <rb> tag and the collation unit 17 further duplicates state information. For example, state information stored in the storage region R0 is duplicated onto the storage region R2 (denoted by an address “010”) and state information stored in the storage region R1 is duplicated onto the storage region R3 (denoted by an address “011”). Information stored in the storage regions R0 to R5 in this case is as depicted as (S5).

Subsequently, the collation unit 17 performs transition based on character information “matsu” which is inserted between <rb> tags for each state information stored in storage regions (the storage region R0 and the storage region R1) having addresses of which the second digit is “0”. The state information stored in the storage region R0 indicates the state (2), so that a transition condition is accordance with “ma”. The character which is read out is “matsu” and is not accorded with “ma”, so that the state information stored in the storage region R0 is updated to the state (0). The state information stored in the storage region R1 indicates the initial state (0) and is not accorded with the transition condition “tana”, so that the state information of the storage region R1 is left as the initial state (0). Information stored in the storage regions R0 to R5 in this case is as depicted as (S6).

Further, the collation unit 17 performs transition based on character information “ma” which is inserted between <rt> tags for each state information stored in storage regions (the storage region R2 and the storage region R3) having addresses of which the second digit is “1”. The state information stored in the storage region R2 indicates the state (2), so that a transition condition is accordance with “ma”. The character which is read out is “ma”, so that state information stored in the storage region R2 is updated to the state (3). The state information stored in the storage region R3 indicates the state (0) and is not accorded with the transition condition “tana”, so that the state information of the storage region R3 is left as the state (0).

Further, the collation unit 17 performs transition based on character information “tsu” for respective state information stored in the storage region R2 and the storage region R3. The state information of the storage region R2 indicates the state (3), so that a transition condition is accordance with “tsu”. The character information “tsu” is read out, so that the collation unit 17 updates the state information of the storage region R2 to the state (4). The state information of the storage region R3 indicates the state (0) and the transition condition “tana” is not satisfied, so that the collation unit 17 maintains the state information stored in the storage region R3 as the state (0). Information stored in the storage regions R0 to R5 in this case is as depicted as (S7).

When the collation unit 17 detects readout of designation for ending the reading notation (</ruby>), the collation unit 17 releases storage regions which store overlapped state information, among a plurality of pieces of state information. In the above-described example, the state information stored in the storage region R0, the state information stored in the storage region R1, and the state information stored in the storage region R3 indicate the state (0), thus being overlapped. For example, the collation unit 17 releases the storage region R1 and the storage region R3.

Further, the collation unit 17 continues collation for character information which is read from the file Fi. When character information “ri” is read out, the collation unit 17 performs transition for respective state information stored in the storage region R0 and the storage region R2. The state information stored in the storage region R0 indicates the state (0). A condition of transition from the state (0) to the state (1) is “tana”. The character information “ri” does not correspond to “tana”, so that the collation unit 17 maintains the state information stored in the storage region R0 as the state (0). The state information stored in the storage region R2 indicates the state (4). A condition of transition from the state (4) to the state (F) is “ri” and the transition condition is satisfied, so that the collation unit 17 updates the state information stored in the storage region R2 to the state (F). Information stored in the storage regions R0 to R5 in this case is as depicted as (S8).

There is such case that document data includes sequence of parts in which it is designated to provide a plurality of notations for a language unit having the same meaning as ““tana” “bata” . . . “ta” “na” “ba” “ta” . . . “matsu” . . . “ma” “tsu” . . . “ri””. The part provided with a plurality of notations is read as ““tana” “bata” “matsu” “ri””, ““ta” “na” “ba” “ta” “matsu” “ri””, ““tana” “bata” “ma” “tsu” “ri””, or ““ta” “na” “ba” “ta” “ma” “tsu” “ri”” on display. However, the document data includes ““tana” “bata” . . . “ta” “na” “ba” “ta” . . . “matsu” . . . “ma” “tsu” . . . “ri””, so that none of ““tana” “bata” “matsu” “ri””, ““ta” “na” “ba” “ta” “matsu” “ri””, ““tana” “bata” “ma” “tsu” “ri””, and ““ta” “na” “ba” “ta” “ma” “tsu” “ri”” correspond to ““tana” “bata” . . . “ta” “na” “ba” “ta” . . . “matsu” . . . “ma” “tsu” . . . “ri””. In the above-described collation, among continuing parts provided with a plurality of notations, collation is performed with respect to character information in which an end (for example, “bata”) of the character information ““tana” “bata”” which is a preceding part in which parent character notation is designated and a head (for example, “ma”) of the character information ““ma” “tsu” “ri”” which is a following part in which reading character notation is designated are continued (for example, ““bata” “ma””). Therefore, even though character information such as ““ta” “na” “ba” “ta”” and “matsu” exist in between as ““tana” “bata” . . . “ta” “na” “ba” “ta” . . . “matsu” . . . “ma” “tsu” . . . “ri””, it is possible to collate and extract ““tana” “bata” “ma” “tsu” “ri”” as continuing character information. Regarding the above-described end and head, it is sufficient that character information which is the preceding part in which parent character notation is designated and character information which is the following part in which reading character notation is designated are continued. Thus, the number of characters is not limited. According to the above-described collation, even though collation with a search string in which a plurality of types of notations are mixed as ““tana” “bata” “ma” “tsu” “ri”” is performed, accordance determination is provided.

According to one aspect of the embodiment, it is possible to suppress such determination that a collation character string and character information having designation of provision of a plurality of types of notations are not accorded with each other, in a case of the character information having designation of provision of a plurality of types of notations and the collation character string in which character information is sequentially displayed when being displayed on the basis of the designation of the provision of a plurality of notations.

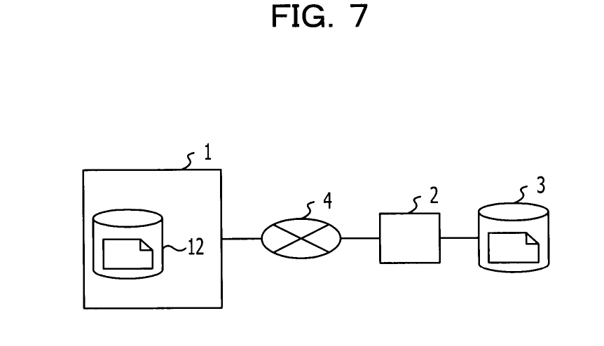

FIG. 7 illustrates the system configuration including the computer 1. A system depicted in FIG. 7 includes the computer 1, a computer 2, a storage device 3, and a network 4. The file group F1 to Fn is stored in the storage unit 12 of the computer 1, but the file group F1 to Fn may be stored in the storage device 3 which is coupled via the network 4, for example. In this case, the readout unit 15 reads out the file group F1 to Fn not from the storage unit 12 but from the storage device 3.

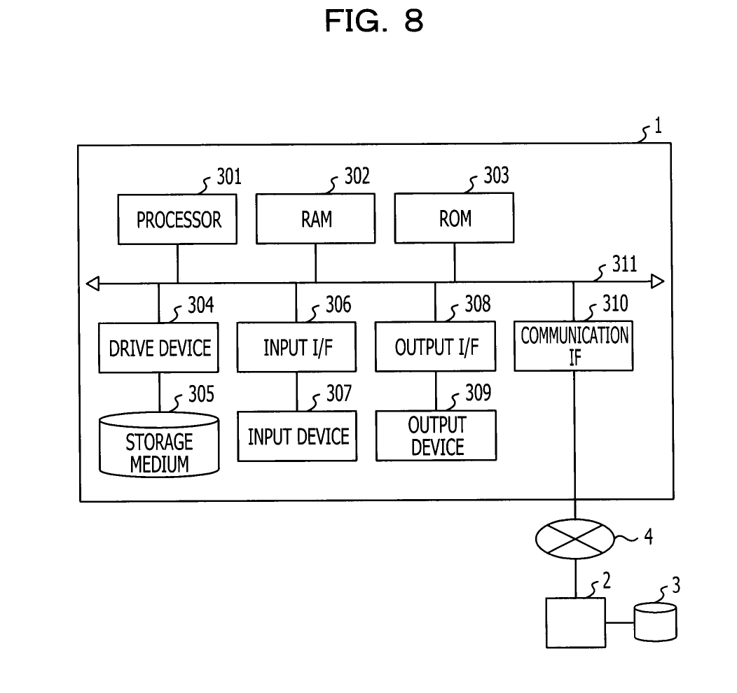

FIG. 8 illustrates a hardware configuration example of the computer 1. Respective function blocks depicted in FIG. 1 are realized by the hardware configuration depicted in FIG. 8, for example. The computer 1 includes a processor 301, a random access memory (RAM) 302, a read only memory (ROM) 303, a drive device 304, a storage medium 305, an input interface (I/F) 306, an input device 307, an output interface (I/F) 308, an output device 309, a communication interface (I/F) 310, and a bus 311, for example. Respective hardware are coupled with each other via bus 311. The communication I/F 310 performs control of communication via the network 4. The input interface 306 is coupled with the input device 307 and transmits an input signal which is received from the input device 307 to the processor 301. The output interface 308 is coupled with the output device 309 and allows the output device 309 to execute output corresponding to an instruction of the processor 301.

The RAM 302 is a readable and writable memory device and is a semiconductor memory such as a static RAM (SRAM) and a dynamic RAM (DRAM), for example. Alternatively, a flash memory may be used instead of a RAM. The ROM 303 includes a programmable ROM (PROM) and the like, as well. The drive device 304 performs at least one of reading and writing of information which is stored in the storage medium 305. The storage medium 305 stores information which is written by the drive device 304. The storage medium 305 is a storage medium such as hard disc, a compact disc (CD), a digital versatile disc (DVD), and a Blu-ray disc, for example. The computer 1 further includes a drive device 304 and a storage medium 305 for each of a plurality of types of storage media, for example.

The input device 307 transmits an input signal in accordance with an operation. The input device 307 is a key device such as a keyboard and a button which is attached to a body of the computer 1 and a pointing device such as a mouse and a touch panel, for example. The output device 309 outputs information in accordance with control of the computer 1. The output device 309 is an image output device (display device) such as a display, an audio output device such as a speaker, and the like, for example. Further, an input/output device such as a touch screen is used as the input device 307 and the output device 309, for example. Alternatively, the input device 307 and the output device 309 may not be included in the computer 1 but may be devices which are coupled to the computer 1 from the outside, for example.

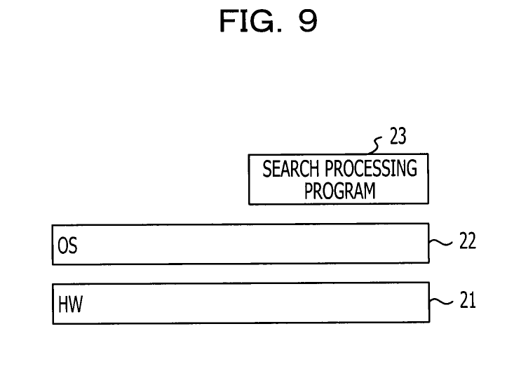

The processor 301 reads out a program which is stored in the ROM 303 and the storage medium 305 onto the RAM 302 and performs processing of the search unit 11 in accordance with a procedure of the program which is read out. At this time, the RAM 302 is used as a work area of the processor 301. The function of the storage unit 12 is realized such that the ROM 303 and the storage medium 305 store a program and the file group F1 to Fn and the RAM 302 is used as a work area of the processor 301. A program which is read out by the processor 301 is described with reference to FIG. 9.

FIG. 9 illustrates a configuration example of software which is operated in the computer 1. An operation system (OS) 22 which controls a hardware group 21 depicted in FIG. 9 operates in the computer 1. The processor 301 operates in a procedure according to the OS 22 so as to control and administrate the hardware 21. Thus, processing by an application program and middleware is executed by the hardware 21. Further, in the computer 1, a search processing program 23 is read out onto the RAM 302 so as to be executed by the processor 301. Further, the processor 301 performs processing based on the search processing program 23 (the processing is performed by controlling the hardware 21 in accordance with the OS 22), realizing the function of the search unit 11.

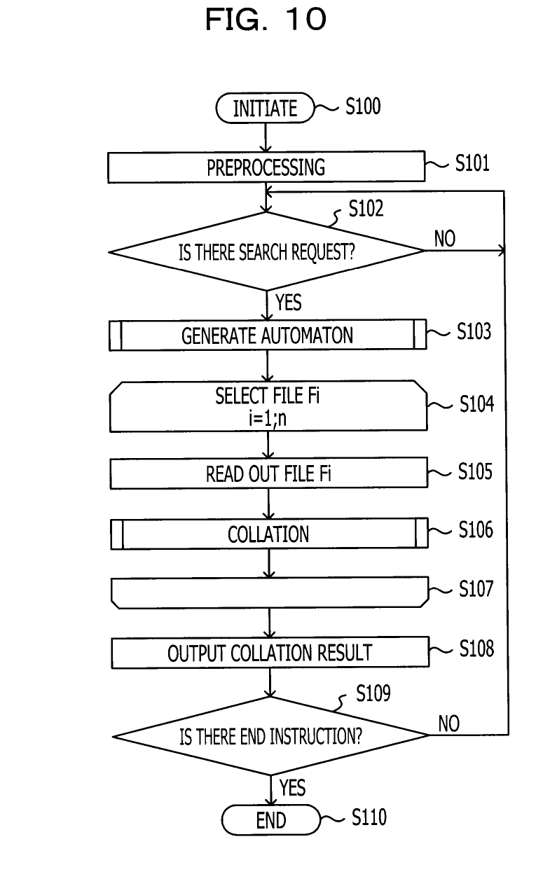

FIG. 10 illustrates a flow of search processing performed by the search unit 11. When the search processing program 23 is initiated (S100), the search unit 11 executes preprocessing (S101). This preprocessing is securement of a storage region for the table T1 and the table T2, acquisition of a file list of the file group F1 to Fn which is read out by the readout unit 15, and the like, for example. The reception unit 13 determines whether or not there is a search request (S102). When the reception unit 13 receives no search request (S102: NO), the reception unit 13 repeats the determination until the reception unit 13 receives a search request. When the reception unit 13 receives a search request, the generation unit 14 generates an automaton which is used for collation between a search string and a character string included in the file group F1 to Fn (S103).

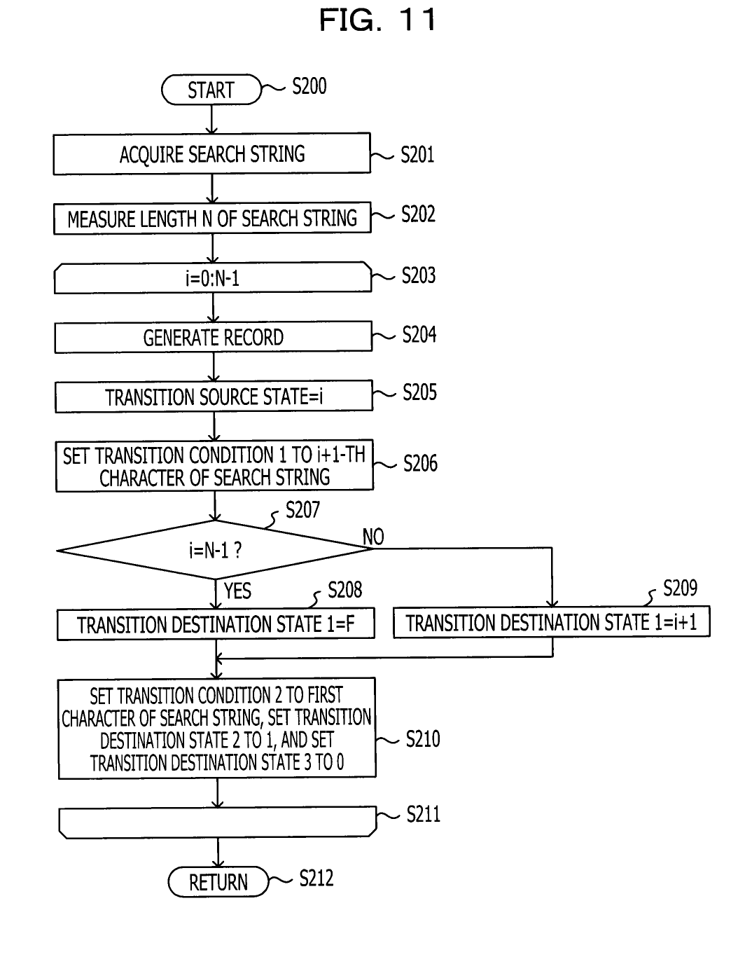

FIG. 11 illustrates an example of a flow in which the generation unit 14 generates an automaton on the basis of a search string. A flow depicted in FIG. 11 may be used in a case where a search string does not include a part, in which character information is repeated, like ““tana” “bata” “ma” “tsu” “ri””. For example, a character string such as ““de” “n” “de” “n” “mushi”” (each of “de”, “n”, “de”, and “n” expresses one Hiragana character and “mushi” expresses one Chinese character in the original specification) includes repetition of character information (““de” “n” is repeated). When an automaton is generated with respect to the search string “de” “n” “de” “n” “mushi””, a flow different from that in FIG. 11 is used. In a case where a character string such as “ . . . “de” “n” “de” “n” “de” “n” “mushi” . . . ” is included in a collation object when the flow illustrated in FIG. 11 is used, the state is shifted up to ““de” “n” “de” “n”” and the following “de” is not accorded with “mushi”. Therefore, an automaton for returning the state to the initial state is generated. If the state is returned to the initial state, the rest of the character string which is ““de” “n” “mushi”” is not accorded with ““de” “n” “de” “n” “mushi””. From the above description, another flow may be used so as to deal with a search string which includes repetition of character information such as ““de” “n” “de” “n” “mushi””.

The generation unit 14 starts processing in response to search request reception of the reception unit 13 (S200). The generation unit 14 first acquires a search string from the search request which is received by the reception unit 13 (S201). Then, the generation unit 14 counts the length N of the acquired search string (S202). The generation unit 14 sequentially selects integer i from 0 to N−1 and repeatedly performs processing from S204 to S210 (S203).

The generation unit 14 adds one record to the table T1 (S204). The generation unit 14 sets a transition source state of the record which is generated in S204 to the integer “i” which is selected in S203 (S205). Further, the generation unit 14 sets a transition condition of the record which is generated in S204 to the i+1-th character of the search string which is acquired in S201 (S206).

Subsequently, the generation unit 14 determines whether or not the integer i is N−1 (S207). When the integer i is N−1 (S207: YES), a transition destination state 1 of the record which is generated in S204 is set to “F (information indicating collation completion)” (S208). When the integer i is not N−1 (S207: NO), the generation unit 14 sets the transition destination state 1 of the record which is generated in S204 to “i+1” (S209).

Further, the generation unit 14 sets a transition condition 2 of the record which is generated in S204 to the first character in the search string, sets a transition destination state 2 to 1, and sets a transition destination state 3 to “0” (S210). After the processing of S210, the generation unit 14 determines whether i is N−1 or not. When i is not N−1, the generation unit 14 selects the next integer in S203 and performs the processing from S204 to S210 (S211). When i is N−1, the generation unit 14 ends the automaton generation processing (S212) and the rest of the search processing flow depicted in FIG. 10 is executed.

The rest of the search processing flow depicted in FIG. 10 is described. When an automaton is generated through the processing of the generation unit 14 (S103), the readout unit 15 selects one file from the file group F1 to Fn (S104). The readout unit 15 reads out the file Fi which is selected in S104, from the storage unit 12 (S105). When S105 is executed, the detection unit 16 and the collation unit 17 perform collation based on the automaton which is generated by the generation unit 14, with respect to character information in the file Fi.

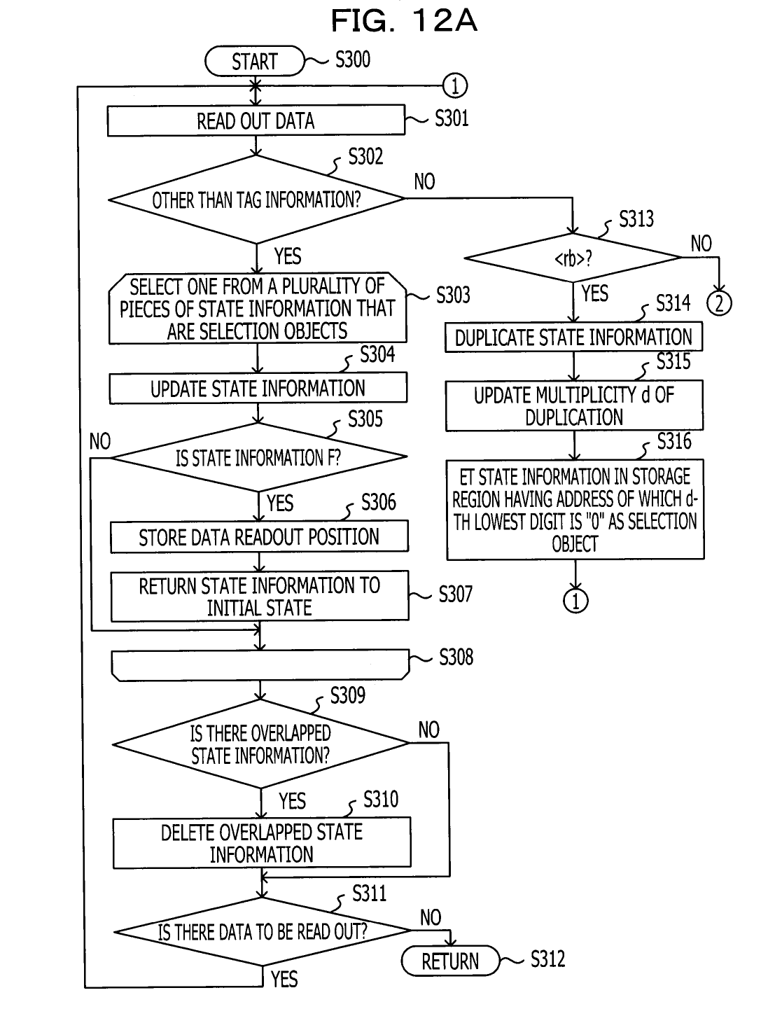

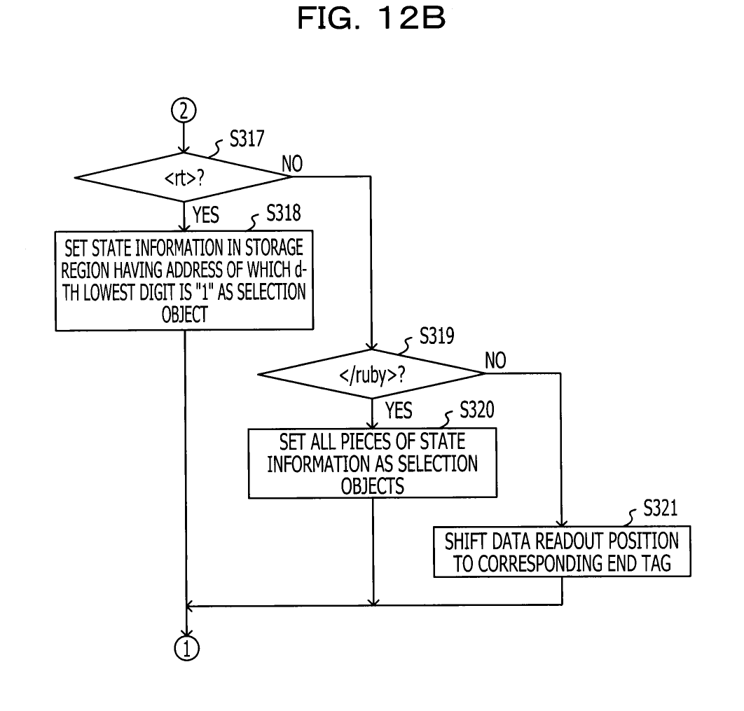

FIGS. 12A and 12B illustrate a flow of collation performed by the collation unit 17. When the collation is started (S300), the collation unit 17 reads out data from the file Fi (S301). A data readout unit is a tag information unit, a character information unit of one character, and the like, for example. Subsequently, the collation unit 17 determines whether or not the data which is read out in S301 is other than tag information (S302).

When the data which is read out in S301 is tag information (S302: NO), the detection unit 16 determines whether or not the tag information which is read out is a <rb> tag (S313). When the tag information which is read out is a <rb> tag (S313: YES), the collation unit 17 duplicates state information which is stored in a storage region (S314). An address of a duplicate destination is specified by multiplicity of duplication and an address of a duplication source, as described above. Further, the collation unit 17 stores multiplicity of duplication (S315). The collation unit 17 confirms the multiplicity of duplication and sets state information in a storage region having an address of which a digit of multiplicity from the lowest is “0” to a selection object, among addresses of storage regions (S316). That is, state information of a duplication source in the duplication of S314 which is performed immediately before is the selection object. When the tag information which is read out is not a <rb> tag (S313: NO), the collation unit 17 determines whether or not the tag information which is read out is a <rt> tag (S317). When the tag information which is read out is a <rt> tag (S317: YES), the collation unit 17 confirms multiplicity of duplication and sets state information in a storage region having an address of which a digit of multiplicity from the lowest is “1” to a selection object, among addresses of storage regions (S318). When the processing of S316 or S318 is performed, the data readout processing of S301 is performed again.

When the tag information which is read out is not a <rt> tag (S317: NO), the collation unit 17 determines whether or not the tag information which is read out is a </ruby> tag (S319). When the tag information which is read out is a </ruby> tag (S319: YES), all pieces of state information which are stored in storage regions are set to selection objects (S320). In S320, the collation unit 17 further sets a flag indicating deletion permission of overlapped state information. This flag is referred in S310 which will be described later. When the tag information which is read out is not a </ruby> tag (S319: NO), the collation unit 17 progresses a position of data readout up to an end tag which corresponds to the tag which is read out (S321).

When the collation unit 17 does not read out tag information but reads out character information in S301, the collation unit 17 selects one piece of state information among state information which are selection objects (S303). The state information being a selection object is state information which is stored in the storage region R0 at the start of the collation. After state information is duplicated in the processing of S314, state information to be a selection object is specified by the processing of S316 or S318.

When the collation unit 17 selects state information in S303, the collation unit 17 performs collation of the character information which is read out and updates the state information which is selected (S304). This updating is performed such that the collation unit 17 acquires a record, in which a transition source state is the selected state information, from the table T1 and stores a transition destination state, which corresponds to whether to satisfy a transition condition included in the acquired record, in a storage region which stores the selected state information, as described above.

When the state information is updated in S304, the collation unit 17 determines whether or not the state information which is updated in S304 indicates “F” (S305). “F” denotes a state indicating an end point of an automaton. When the state information is “F” in the determination of S305 (S305: YES), identification information of the file Fi and information which indicates a position, in the file, of the character information which is read out in S301 are stored in the table T2 (S306). After the processing of S306, the collation unit 17 further updates the updated state information to the initial state (0) (S307). When the state information is not “F” in the determination of S305 (S305: NO) or when the processing of S307 is performed, the collation unit 17 determines whether or not there is state information which has not been selected among state information which are selection objects. When there is state information which has not been selected, the collation unit 17 performs the processing of S303 again so as to select state information which has not been selected (S308). In a case where there is no state information which has not been selected, the collation unit 17 performs processing of S309.

The collation unit 17 determines whether or not there is state information indicating same state information in an overlapped manner among state information which are stored in storage regions (S309). When there is overlapped state information (S309: YES), the collation unit 17 confirms whether a flag indicating deletion permission of the overlapped state information is set by the processing of S320. When a flag indicating deletion permission is set, the collation unit 17 releases the storage region which stores the overlapped state information and further, removes the overlapped state information from state information which is an selection object (S310). Further, when the number of pieces of state information becomes to be only one through the processing of S310, the collation unit 17 clears the flag indicating deletion permission. When there is no overlapped state information in the processing of S309 (S309: NO) or when the processing of S310 is performed, the collation unit 17 determines whether or not there is character information to be read from the file Fi (S311). When there is character information to be read out in the file Fi (S311: YES), the collation unit 17 performs the processing of S301 again. When there is no character information to be read out in the file Fi (S311: NO), the collation is ended and the flow of the search processing depicted in FIG. 10 is performed (S312).

The rest of the search processing flow depicted in FIG. 10 is described. When the collation of S106 is ended, the readout unit 15 determines whether or not there is an unselected file in the file group F1 to Fn. When there is an unselected file, the readout unit 15 performs the processing of S104 again (S107). When there is no unselected file, the output unit 18 outputs a collation result obtained by the collation unit 17 (S108). The output of a collation result is display of information which is stored in the table T2, for example. Further, character information including vicinity of a part indicated in each record of the table T2 may be read out to be displayed. Further, each file of the file group F1 to Fn and address information indicating a storage destination of a file may be preliminarily associated with each other so as to output address information which is associated with a file ID which is stored in the table T2.

When the processing of S108 is ended, the search unit 11 determines whether or not an end instruction of the search processing program 23 is given (S109). When the end instruction is not given (S109: NO), the reception unit 13 performs the processing of S102 again. When the end instruction is given (S109: YES), the search unit 11 ends the search processing program 23 (S110).

According to the above-described processing, it is possible to extract a character string which includes both of a parent character part and a reading character part, as a character string according with a search string, from document data which is a search object.

In the above description, state information is duplicated in response to detection of a <rb> tag. However, a catalyst for duplication of state information may be arbitrarily changed depending on a language to be used. Any catalyst for duplication is applicable as long as the catalyst indicates start of enumeration of a plurality of types of character information, in designation of notation by a plurality of types of character information which have one meaning. For example, in a grammar in which a character which is inserted between <ruby> tags and is not inserted between <rt> tags is set as a parent character without using <rb> tags, it is sufficient to duplicate state information in response to detection of a <ruby> tag.

An example in which reading with respect to Chinese characters is displayed has been described above, but the embodiment is not limited to this example. Reading may be provided with respect to Katakana characters and pinyin may be provided to notations of Chinese characters in Chinese language.

Further, reading is used for English and the above-described example of the embodiment is applicable to English. For example, BIOS (basic input/output system) is sometimes expressed by a description (description D2) such as <ruby><rb>B</rb><rp>(</rp><rt>BASIC</rt><rp>)</rp><rb>I</rb><rp>(</rp><rt>INPUT/</rt><rp>)</rp><rb>O</rb><rp>(</rp><rt>OUTPUT</rt><rp>)</rp><rb>S</rb><rp>(</rp><rt>SYSTEM</rt><rp>)</rp></ruby>. “BIOS”, “BASICINPUT/OUTPUTSYSTEM”, or “BASICIOSYSTEM” may be inputted as a search string, for example.

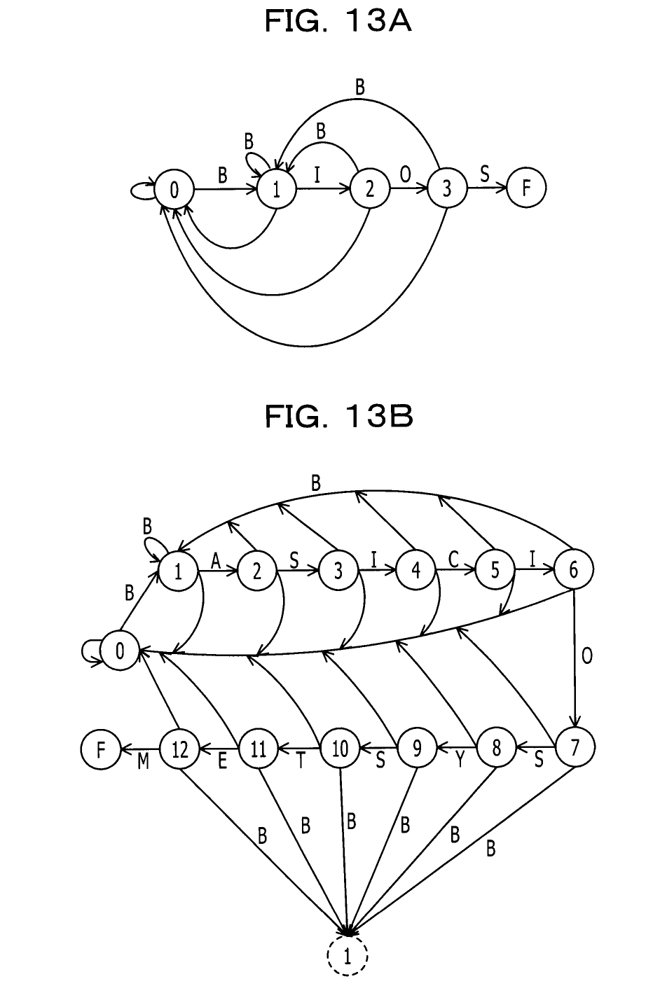

FIG. 13A illustrates an automaton corresponding to a search string “BIOS”. A transition condition 1 in an initial state (0) (a corresponding transition destination state 1 is “1”) is “B”. A transition condition 1 in a state (1) (a corresponding transition destination state 1 is “2”) is “I”, and a transition condition 2 (a corresponding transition destination state 2 is “1”) is “B”. A transition condition 1 in a state (2) (a corresponding transition destination state 1 is “3”) is “O”, and a transition condition 2 (a corresponding transition destination state 2 is “1”) is “B”. A transition condition 1 in a state (3) (a corresponding transition destination state is “F”) is “S”, and a transition condition 2 (a corresponding transition destination state is “1”) is “B”.

FIG. 13B illustrates an automaton corresponding to “BASICIOSYSTEM”. A transition condition 1 in an initial state (0) (a corresponding transition destination state 1 is “1”) is “B”. A transition condition 1 in a state (1) (a corresponding transition destination state 1 is “2”) is “A”, and a transition condition 2 (a corresponding transition destination state 2 is “1”) is “B”. A transition condition 1 in a state (2) (a corresponding transition destination state 1 is “3”) is “S”, and a transition condition 2 (a corresponding transition destination state 2 is “1”) is “B”. A transition condition 1 in a state (3) (a corresponding transition destination state 1 is “4”) is “I”, and a transition condition 2 (a corresponding transition destination state 2 is “1”) is “B”. A transition condition 1 in a state (4) (a corresponding transition destination state 1 is “5”) is “C”, and a transition condition 2 (a corresponding transition destination state 2 is “1”) is “B”. A transition condition 1 in a state (5) (a corresponding transition destination state 1 is “6”) is “I”, and a transition condition 2 (a corresponding transition destination state 2 is “1”) is “B”. A transition condition 1 in a state (6) (a corresponding transition destination state 1 is “7”) is “O”, and a transition condition 2 (a corresponding transition destination state 2 is “1”) is “B”. A transition condition 1 in a state (7) (a corresponding transition destination state 1 is “8”) is “S”, and a transition condition 2 (a corresponding transition destination state 2 is “1”) is “B”. A transition condition 1 in a state (8) (a corresponding transition destination state 1 is “9”) is “Y”, and a transition condition 2 (a corresponding transition destination state 2 is “1”) is “B”. A transition condition 1 in a state (9) (a corresponding transition destination state 1 is “10”) is “S”, and a transition condition 2 (a corresponding transition destination state 2 is “1”) is “B”. A transition condition 1 in a state (10) (a corresponding transition destination state 1 is “11”) is “T”, and a transition condition 2 (a corresponding transition destination state 2 is “1”) is “B”. A transition condition 1 in a state (11) (a corresponding transition destination state 1 is “12”) is “E”, and a transition condition 2 (a corresponding transition destination state 2 is “1”) is “B”. A transition condition 1 in a state (12) (a corresponding transition destination state 1 is “F”) is “M”, and a transition condition 2 (a corresponding transition destination state 2 is “1”) is “B”.

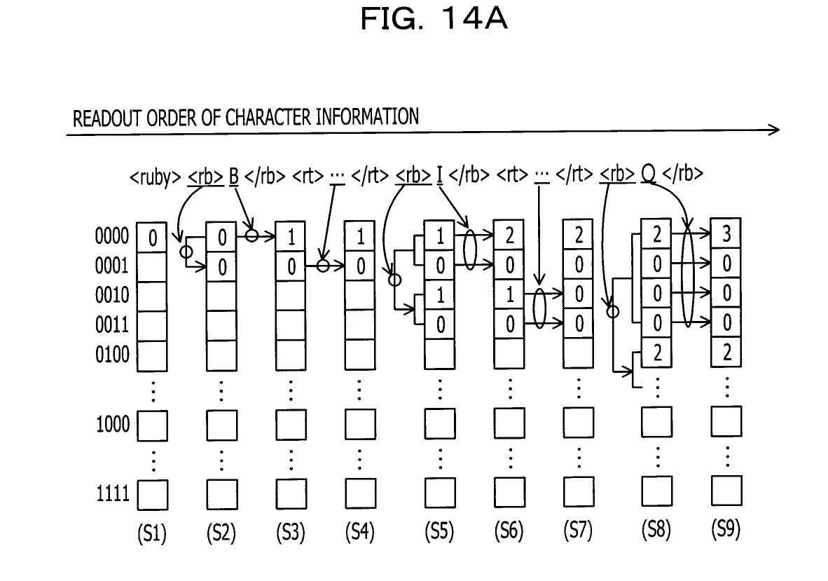

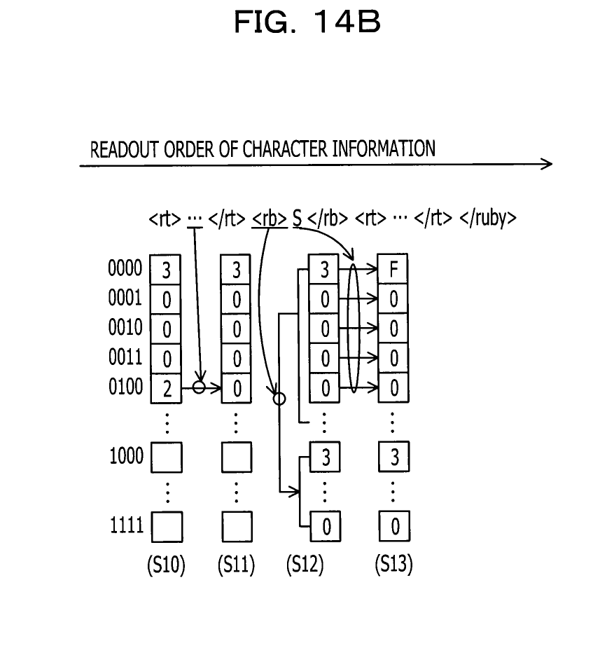

FIGS. 14A and 14B illustrate a collation procedure for whether or not “BIOS” is accorded with the description D2. The collation unit 17 updates state information which is stored in the storage region, on the basis of the automaton depicted in FIG. 13A.

It is assumed that only state information indicating the initial state (0) is stored in a storage region 0000 before readout of the description D2 (S1). When the collation unit 17 reads out a <rb> tag from the file Fi, the collation unit 17 copies the state information which is stored in the storage region 0000 onto a storage region 0001 (S2). Here, the collation unit 17 sets multiplicity d to “1”. Then, when the collation unit 17 reds out “B”, the collation unit 17 updates the state information which is stored in the storage region 0000, in accordance with the automaton depicted in FIG. 13A. A condition of transition from the initial state (0) to the state (1) is “B”, so that state information which is stored in the storage region 0000 is the state (1) (S3). When the collation unit 17 reads out <rt>, the collation unit 17 shifts a storage region of an updating object to the region 0001. The collation unit 17 updates state information which is stored in the storage region 0001 in response to readout of each of “B”, “A”, “S”, “I”, and “C”. As a result, the state information of the storage region 0001 is updated to the initial state (0) (S4).

When the collation unit 17 reads out a <rb> tag from the file Fi, the collation unit 17 copies state information which is stored in the storage region 0000 and the storage region 0001 respectively onto a storage region 0010 and a storage region 0011 (S5). Here, the collation unit 17 sets the multiplicity d to “2”. Subsequently, when the collation unit 17 reds out “I”, the collation unit 17 updates the state information which is stored in the storage region 0000, in accordance with the automaton depicted in FIG. 13A. A condition of transition from the state (1) to the state (2) is “I”, so that state information which is stored in the storage region 0000 becomes to be in the state (2). Further, a condition of transition from the initial state (0) to the state (1) is “B”, so that state information which is stored in the storage region 0001 is the initial state (0) (S6). When the collation unit 17 reads out <rt>, the collation unit 17 shifts a storage region of an updating object to the storage region 0010 and the storage region 0011. The collation unit 17 updates state information which is stored in the storage region 0010 and the storage region 0011, in response to readout of each of “I”, “N”, “P”, “U”, “T”, and “/”. As a result, the state information of the storage region 0010 and the storage region 0011 is updated to the initial state (0) (S7).

When the collation unit 17 reads out a <rb> tag from the file Fi, the collation unit 17 copies state information which is stored in the storage regions 0000 to 0011 respectively onto storage regions 0100 to 0111 (S8). Here, the collation unit 17 sets the multiplicity d to “3”. Subsequently, when the collation unit 17 reds out “O”, the collation unit 17 updates the state information which is stored in the storage region 0000, in accordance with the automaton depicted in FIG. 13A. A condition of transition from the state (2) to the state (3) is “O”, so that the state information which is stored in the storage region 0000 is the state (3). Further, a condition of transition from the initial state (0) to the state (1) is “B”, so that the state information which is stored in the storage regions 0001 to 0011 is the initial state (0) (S9). When the collation unit 17 reads out <rt>, the collation unit 17 shifts the storage region of an updating object to storage regions 0100 to 0111 (S10). The collation unit 17 updates state information which is stored in the storage regions 0100 to 0111, in response to readout of each of “O”, “U”, “T”, “P”, “U”, and “T”. As a result, the state information of the storage regions 0100 to 0111 is updated to the initial state (0) (S11).

When the collation unit 17 reads out a <rb> tag from the file Fi, the collation unit 17 copies the state information which is stored in the storage regions 0000 to 0111 respectively onto storage regions 1000 to 1111 (S12). Here, the collation unit 17 sets the multiplicity d to “4”. Subsequently, when the collation unit 17 reads out “S”, the collation unit 17 updates the state information which is stored in the storage region 0000, in accordance with the automaton depicted in FIG. 13A. A condition of transition from the state (3) to the state (F) is “S”, so that state information which is stored in the storage region 0000 is the state (F). Further, a condition of transition from the initial state (0) to the state (1) is “B”, so that the state information which is stored in the storage regions 0001 to 0111 is the initial state (0) (S13). The state information stored in the storage region 0000 indicates the state (F), so that the collation unit 17 determines that the description D2 includes “BIOS”.

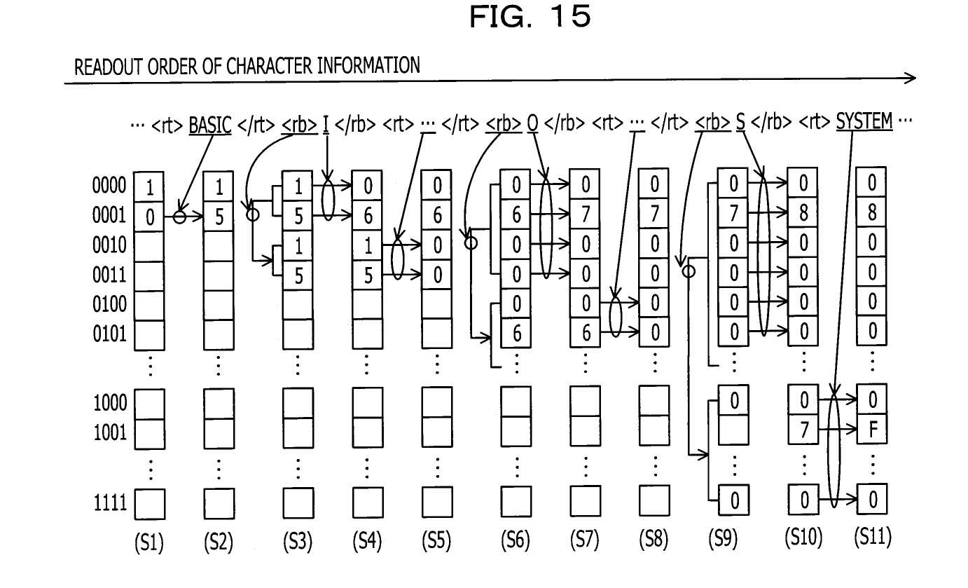

FIG. 15 illustrates a collation procedure for whether or not “BASICIOSYSTEM” is accorded with a description D2. The collation unit 17 updates state information which is stored in a storage region on the basis of the automaton depicted in FIG. 13B.

The collation unit 17 copies state information which is stored in the storage region 0000 onto the storage region 0001 in response to readout of a <rb> tag from the file Fi (S1). Here, the collation unit 17 sets the multiplicity d to “1”. Subsequently, when the collation unit 17 reads out “B”, “A”, “S”, “I”, and “C” in sequence, the collation unit 17 updates the state information which is stored in the storage region 0001 in accordance with the automaton depicted in FIG. 13B. A condition of transition from the initial state (0) to the state (1) is “B”, so that the state information which is stored in the storage region 0001 is the state (1). Further, each of “A”, “S”, “I”, and “C” satisfies a transition condition which is expressed in the automaton depicted in FIG. 13B, so that the state information which is stored in the storage region 0001 is the state (5) (S2).

When the collation unit 17 reads out a <rb> tag from the file Fi, the collation unit 17 copies the state information which is stored in the storage region 0000 and the storage region 0001 respectively onto the storage region 0010 and the storage region 0011 (S3). Here, the collation unit 17 sets the multiplicity d to “2”. Subsequently, when the collation unit 17 reads out “I”, the collation unit 17 updates the state information which is stored in the storage region 0000 and the storage region 0001 in accordance with the automaton depicted in FIG. 13B. A condition of transition from the state (5) to the state (6) is “I”, so that the state information which is stored in the storage region 0001 is the state (6). Further, a condition of transition from the state (1) to the state (2) is “A”, so that the state information which is stored in the storage region 0000 is the initial state (0) (S4). When the collation unit 17 reads out <rt>, the collation unit 17 shifts the storage region of an updating object to the storage region 0010 and the storage region 0011. The collation unit 17 updates the state information which is stored in the storage region 0010 and the storage region 0011, in response to readout of each of “I”, “N”, “P”, “U”, “T”, and “/”. As a result, the state information of the storage region 0010 and the storage region 0011 is updated to the initial state (0) (S5).

When the collation unit 17 reads out a <rb> tag from the file Fi, the collation unit 17 copies state information which is stored in the storage regions 0000 to 0011 respectively onto storage regions 0100 to 0111 (S6). Here, the collation unit 17 sets the multiplicity d to “3”. Subsequently, when the collation unit 17 reads out “O”, the collation unit 17 updates the state information which is stored in the storage regions 0000 to 0011, in accordance with the automaton depicted in FIG. 13B. A condition of transition from the state (6) to the state (7) is “O”, so that the state information which is stored in the storage region 0001 is the state (7). Further, a condition of transition from the initial state (0) to the state (1) is “B”, so that the state information which is stored in the storage regions 0000, 0010, and 0011 becomes to be in the initial state (0) (S7). When the collation unit 17 reads out <rt>, the collation unit 17 shifts the storage region of an updating object to storage regions 0100 to 0111. The collation unit 17 updates state information which is stored in the storage regions 0100 to 0111, in response to readout of each of “O”, “U”, “T”, “P”, “U”, and “T”. As a result, the state information of the storage regions 0100 to 0111 is updated to the initial state (0) (S8).

When the collation unit 17 reads out a <rb> tag from the file Fi, the collation unit 17 copies the state information which is stored in the storage regions 0000 to 0111 respectively onto storage regions 1000 to 1111 (S9). Here, the collation unit 17 sets the multiplicity d to “4”. Subsequently, when the collation unit 17 reads out “S”, the collation unit 17 updates the state information which is stored in the storage regions 0000 to 0111, in accordance with the automaton depicted in FIG. 13B. A condition of transition from the state (3) to the state (8) is “S”, so that the state information which is stored in the storage region 0001 is the state (8). Further, a condition of transition from the initial state (0) to the state (1) is “B”, so that the state information which is stored in the storage regions 0000 and 0010 to 0111 is the initial state (0) (S10).

When the collation unit 17 reads out <rt>, the collation unit 17 shifts the storage region of an updating object to the storage regions 1000 to 1111. The collation unit 17 updates the state information which is stored in the storage regions 1000 to 1111, in response to readout of “S”, “Y”, “S”, “T”, “E”, and “M”. “S”, “Y”, “S”, “T”, “E”, and “M” satisfy respective transition conditions from the state (8) to the state (F), so that the state information which is stored in the storage region 1001 is the state (F). Further, a condition of transition from the initial state (0) to the state (1) is “B”, so that the state information which is stored in the storage regions 1000 and 1010 to 1111 is the initial state (0) (S11). The state information stored in the storage region 1001 indicates the state (F), so that the collation unit 17 determines that the description D2 is accorded with “BASICIOSYSTEM”.

Application of the above-described embodiment enables extraction of the description D2 as character information which is accorded with a search string in any cases where the search string is “BIOS”, “BASICINPUT/OUTPUTSYSTEM”, or “BASICIOSYSTEM”.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A searching apparatus comprising:
a processor configured to:
receive searching character information;
in a case that document data includes a designation that first character information and second character information are provided in adscript description, copy state information indicating a state of a collating process of the searching character information on third character information in front of the designation in the document data;
update the state information based on a result of collating the first character information with the searching character information; and
update the copied state information based on a result of collating the second character information with the searching character information.

2. The searching apparatus according to claim 1, wherein
the first character information is a first notation of a certain linguistic unit, and
the second character information is a second notation of the certain linguistic unit.

3. The searching apparatus according to claim 1, wherein
the second character information is displayed as ruby annotation of the first character information.

4. The searching apparatus according to claim 1, wherein
the processor is configured to respectively update the updated state information and the updated copied state information based on a result of collating fourth character information that follows the first character information and the second character information in the document data with the searching information.

5. The searching apparatus according to claim 1, wherein
the processor is configured to further copy the state information and the copied state information respectively, in a case that another designation, indicating fifth character information and sixth character information are provided in adscript description, is included posteriorly to the designation in the document data.

6. The searching apparatus according to claim 1, wherein
the processor is configured to delete one of the state information and the copied state information, in a case that the copied state information is same as the state information.

7. A searching method, comprising:
receiving searching character information;
in a case that document data includes a designation that first character information and second character information are provided in adscript description, copying state information indicating a state of a collating process of the searching character information on third character information in front of the designation in the document data, by a processor; and
updating the state information based on a result of collating the first character information with the searching character information, and the copied state information based on a result of collating the second character information with the searching character information.

8. The searching method according to claim 7, wherein
the first character information is a first notation of a certain linguistic unit, and
the second character information is a second notation of the certain linguistic unit.

9. The searching method according to claim 7, wherein
the second character information is displayed as ruby annotation of the first character information.

10. The searching method according to claim 7, further comprising:
updating the updated state information and the updated copied state information respectively based on a result of collating fourth character information that follows the first character information and the second character information in the document data with the searching information.

11. The searching method according to claim 7, further comprising:
copying the state information and the copied state information respectively, in a case that another designation, indicating fifth character information and sixth character information are provided in adscript description, is included posteriorly to the designation in the document data.

12. The searching method according to claim 7, wherein
deleting one of the state information and the copied state information, in a case that the copied state information is same as the state information.

13. A computer-readable recording medium storing a searching program that causes a computer to execute:
receiving searching character information;
in a case that document data includes a designation that first character information and second character information are provided in adscript description, copying state information indicating a state of a collating process of the searching character information on third character information in front of the designation in the document data; and
updating the state information based on a result of collating the first character information with the searching character information, and the copied state information based on a result of collating the second character information with the searching character information.

14. The recording medium according to claim 13, wherein
the first character information is a first notation of a certain linguistic unit, and
the second character information is a second notation of the certain linguistic unit.

15. The recording medium according to claim 13, wherein
the second character information is displayed as ruby annotation of the first character information.

16. The recording medium according to claim 13, wherein the searching program further causes the computer to execute:
updating the updated state information and the updated copied state information respectively based on a result of collating fourth character information that follows the first character information and the second character information in the document data with the searching information.

17. The recording medium according to claim 13, wherein the searching program further causes the computer to execute:
copying the state information and the copied state information respectively, in a case that another designation, indicating fifth character information and sixth character information are provided in adscript description, is included posteriorly to the designation in the document data.

18. The recording medium according to claim 13, wherein
deleting one of the state information and the copied state information, in a case that the copied state information is same as the state information.
